(19) United States
(12) Patent Application Publication
(10) Pub. No.: US 2013/0011181 A1
(43) Pub. Date: Jan. 10, 2013

(54) LATCHING FITTING

(76) Inventor: Hoger Riedmueller, Balingen (DE)

(21) Appl. No.: 13/634,044

(22) PCT Filed: Mar. 1, 2011
(86) PCT No.: PCT/EP11/53006

§ 371 Date: Sep. 25, 2012

(30) Foreign Application Priority Data
Mar. 12, 2010 (DE) 20 2010 000 368.7

(51) Int. Cl. A47C 1/025; F16C 11/10

(52) U.S. Cl. 403/84

(57) ABSTRACT

A latching fitting (1), in particular for adjusting furniture parts, comprises a first lever (2, 2′, 2″) and a second lever (3) which is mounted on said first lever in a rotatable manner, wherein a tooth system (5) which is arranged in the form of a ring around a rotation axis is arranged on the first lever (2, 2′, 2″), said tooth system engaging with a toothed ring (8), wherein the tooth system (5) and the toothed ring (8) are locked to one another in a first direction of rotation and can be rotated relative to one another through a predetermined angular range in a second direction of rotation, wherein the toothed ring (8) is in the form of a ring and can be displaced parallel to the rotation axis, relative to a coupling element (7) which is arranged in the toothed ring (8), by means of a switching element (6).

The present invention relates to a latching fitting, especially for adjusting furniture parts, comprising a first lever and a second lever which is mounted on said first lever in a rotatable manner, with a tooth system which is arranged in the form of a ring around a rotational axis being arranged on the first lever, which tooth system engages with a toothed ring, with the tooth system and the toothed ring being locked with respect to one another in a first direction of rotation and being rotatable relative to one another about a predetermined angular range in a second direction of rotation.

DE 20 2006 004 076 discloses a latching joint which comprises a first and a second articulated arm, which are coupled with one another via a latching mechanism. A toothed ring is formed on one articulated arm, which toothed ring is in engagement with a disk-like toothed ring element. The toothed ring element can be lifted in the axial direction by a lifting disk upon reaching an end position in order to bring the tooth system out of engagement. As a result, the articulated arms can be pivoted back to an initial position until the tooth system which is unilaterally provided with a freewheel comes back into engagement again. The toothed ring element is pretensioned in the axial direction by a helical spring, with the configuration having a relatively large volume as a result of the arrangement of the spring and the lifting of the toothed disk. Furthermore, the formation of the tooth system on the articulated lever is disadvantageous because there cannot be any flexible adjustment with respect to the adjusting angle and the configuration of the lever.

It is therefore the object of the present invention to provide a latching fitting which can be adjusted flexibly to the respective purpose and comes with a compact configuration.

This object is achieved by a latching fitting with the features of claim 1.

In accordance with the invention, the toothed ring is arranged in the manner of a ring and is displaceable parallel to the rotational axis relative to a coupling element arranged in the toothed ring, so that for unlocking the toothed ring with the tooth system only the annular toothed ring is displaced while the coupling element remains axially stationary and is coupled with the second lever. As a result, the latching fitting can be arranged in an especially compact way, wherein an adjustment of the adjusting angle can further occur in such a way that the angular position of the coupling element is changed relative to the second lever. This provides a simple possibility for adjustment, depending on whether the latching fitting is used for setting backrests, armrests, foot parts or other adjustable furniture parts.

Preferably, the coupling element comprises a profiling on the outer circumference which is in engagement in an interlocking fashion with a profiling on the toothed ring, so that a torsion-proof connection is ensured between the coupling element and the toothed ring, irrespective of whether the toothed ring is lifted off from the tooth system or is in engagement with the same. The coupling element is further provided with at least one driver on the side facing the second lever, said driver being coupled with the second lever so that a torsion-proof connection is also produced here. The coupling element can comprise several projections in the axial direction which are inserted into respective receivers or openings in the second lever. As a result, the coupling element can be fixed in different angular positions on the second lever in a simple way, especially when the projections are arranged on an annular orbit and annularly arranged openings are accordingly provided on the second lever.

In accordance with a further embodiment of the invention, the tooth system on the first lever is arranged as a separate component which can be fixed in different angular positions to the first lever. A simple adjustment to the adjustable angular range can also occur in that the position of the tooth system is set relative to the first lever. Several openings and/or projections which are distributed over an annular path can also be provided in this case, so that simple mounting in different angular positions is enabled.

A latching disk is preferably provided as a switching element, on which at least one guide bevel is provided for displacing the toothed ring in the axial direction. The latching disk can be arranged between the coupling element and the tooth system, and can comprise several guide bevels which are distributed on the outer circumference, especially three or four guide bevels, so that the oblique positioning of the toothed ring is prevented when the tooth system is lifted. The toothed ring can comprise at least one projection on its inner face edge, preferably three or four projections, which are movable along a guide bevel of the latching disk. The guide bevel can be arranged in V-like manner, so that constant movement occurs in the axial direction both during lifting and also during lowering of the toothed ring. This constant movement in the axial direction can be influenced by the size of the angles of the V-like guide bevels. The further the angles of the V-like guide bevels are arranged, the longer the inclined planes and the larger the delay in the lowering (threading) of the toothed ring. This relatively delayed lowering of the toothed ring comes with the advantage that loud impact noises are dampened thereby.

For an especially compact configuration, the toothed ring is pretensioned towards the tooth system via a leaf spring arranged between the second lever and the toothed ring. The leaf spring can comprise an annular inner section which is supported on the second lever and comprises outer limbs which rest on the toothed ring.

Preferably, the toothed ring is fixed by at least one pin to the first lever and the pin penetrates an oblong hole of a latching disk. The angular range can be predetermined thereby in that the tooth system is in engagement with the toothed ring because the latching disk predetermines the adjustable angular range via the length of the oblong hole. The length of the oblong hole or holes in the latching disk can be set by exchanging the latching disk.

For the purpose of especially stable transmission of forces, the teeth of the tooth system and the toothed ring may comprise an undercut arranged in an inclined manner in relation to the rotational axis. It has been noticed that in the transmission of large torques a slightly inclined arrangement of the teeth will ensure that the teeth will hook into each other as a result of an application of force.

The invention will be explained below by reference to several embodiments shown in the enclosed drawings, wherein:

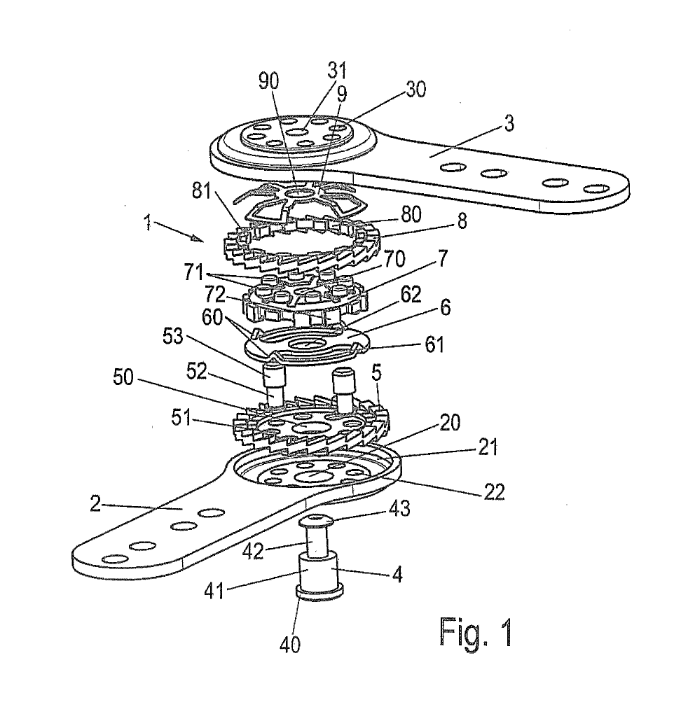

FIG. 1 shows a perspective exploded view of an embodiment of a latching fitting in accordance with the invention;

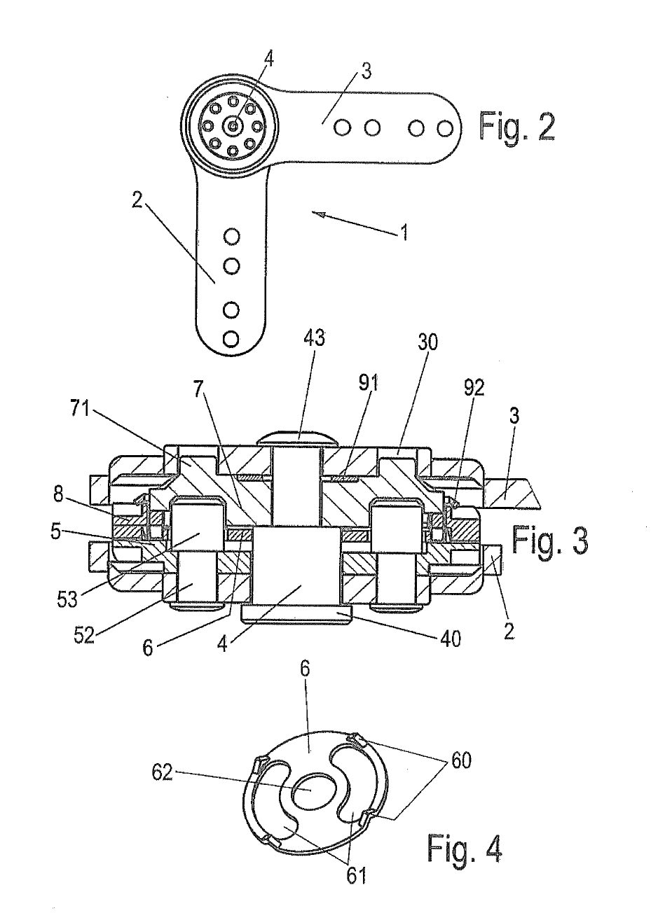

FIG. 2 shows a top view of the latching fitting of FIG. 1 in the mounted position;

FIG. 3 shows an intersected side view of the latching fitting of FIG. 1 in the mounted position;

FIG. 4 shows a perspective detailed view of the latching disk;

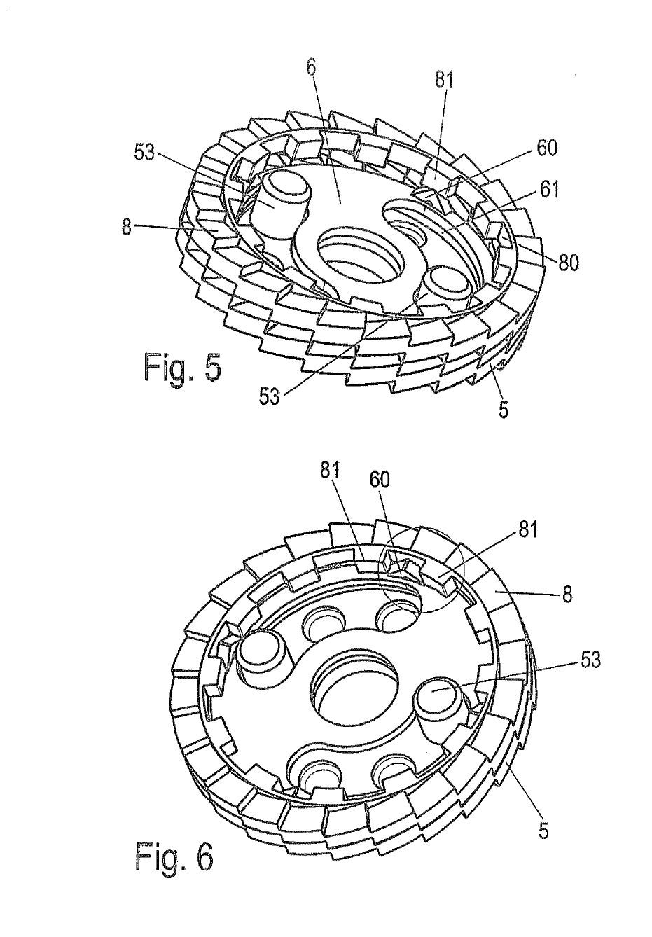

FIG. 5 shows a perspective view of the toothed ring and the tooth system in a lifted position;

FIG. 6 shows a perspective view of the toothed ring and the tooth system in a lowered position;

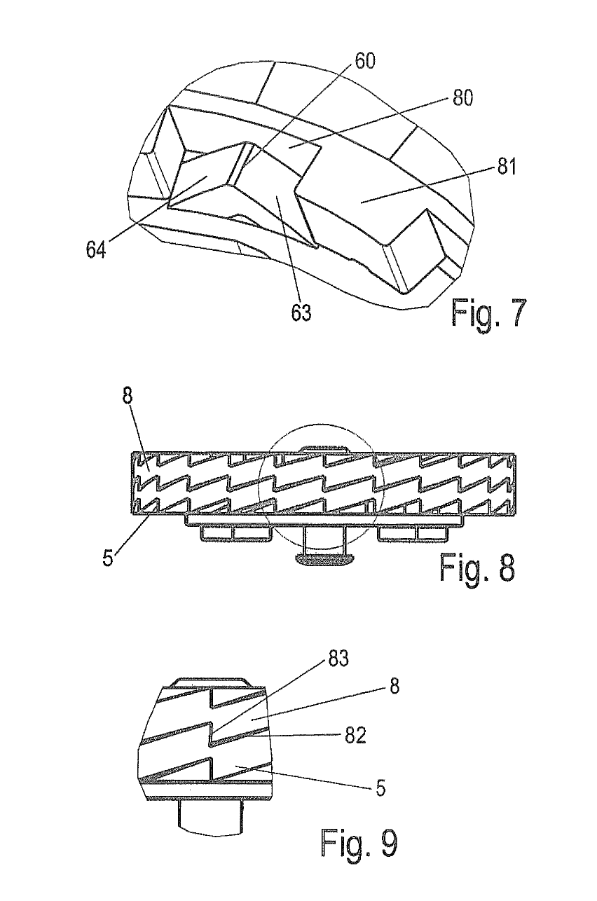

FIG. 7 shows a detailed view of the toothed ring in the lowered position;

FIG. 8 shows a side view of the tooth system and the toothed ring;

FIG. 9 shows a detailed view of the tooth system and the toothed ring;

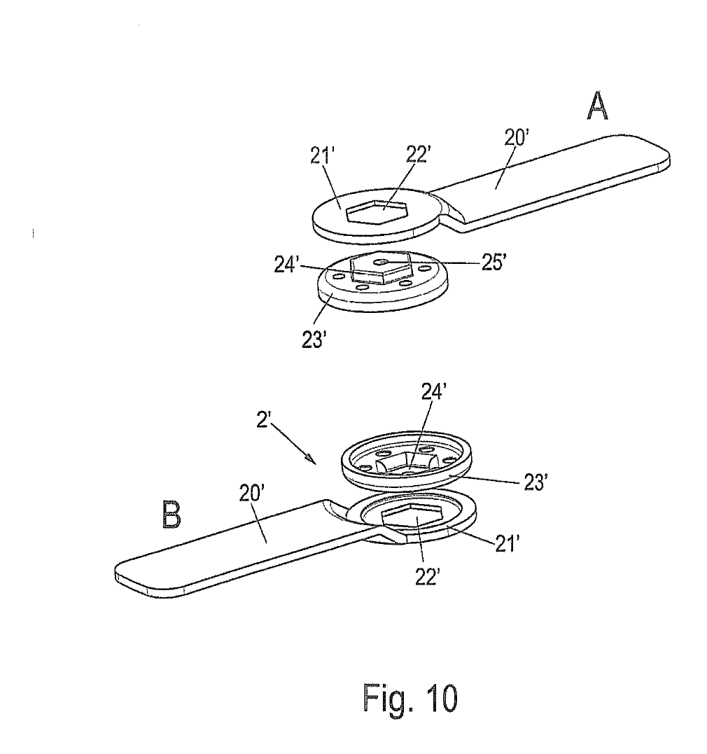

FIGS. 10A and 10B show two views of a modified lever of a latching fitting in accordance with the invention, and

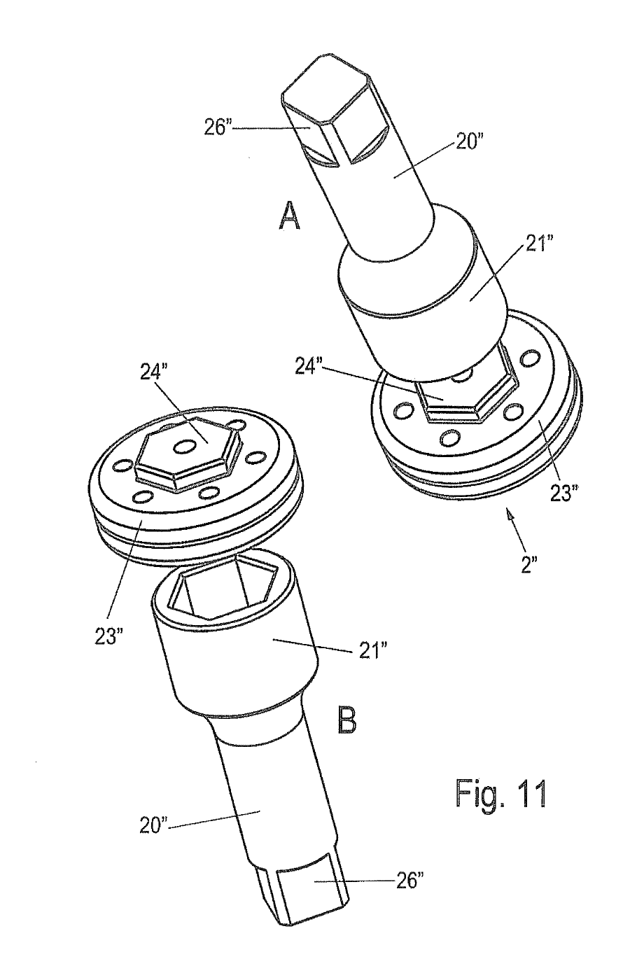

FIGS. 11A and 11B show two views of a further modified lever of a latching fitting in accordance with the invention.

A latching fitting 1 is used for adjusting furniture parts such as armrests or backrests, headrests, foot parts, flaps in cabinet furniture or other adjustable components. A first lever 2 is rotatably held about a rotational axis relative to a second lever 3, with a central rivet 4 being provided for bearing which penetrates an opening 20 in the lever 2 and an opening 31 in the lever 3.

A dished receiver 21 is formed on the lever 2, in which a tooth system 5 is inserted. The tooth system 5 comprises a middle opening 50, through which the central rivet 4 is guided. Furthermore, the disk-like tooth system 5 comprises annularly arranged openings 51 which are arranged in alignment to the openings 22 on the receiver 21. Pins 52 are inserted into two of these openings 21, so that the tooth system 5 is connected in a torsion-proof manner with the lever 2. The position of the tooth system 5 can be set relative to the lever 2 by the pins 52.

A switching element in form of a latching disk 6 is adjacently arranged on the tooth system 5, which latching disk comprises a central opening 62 which is penetrated by the central rivet 4. The latching disk 6 further comprises two curved oblong holes 61 which are respectively penetrated by an enlarged section 53 of the pin 52. Four upwardly projecting V-like projections 16 are arranged on the outer circumference on the latching disk 6, which projections are used for lifting a toothed ring 8.

The toothed ring 8 comprises a plurality of teeth which are in engagement with teeth of the tooth system 5. The toothed ring 8 is arranged in the manner of an annulus and comprises projections 81 and recesses 80 on its inner face edge. The profiling formed in this manner with the recesses 80 and the projections 81 is in engagement in an interlocking manner with a profiling of a coupling element 7 which is arranged within the toothed ring 8. The coupling element comprises an opening 70 which is penetrated by the central rivet 4. Projections 72 are provided on the outer circumference of the coupling element 7, which projections are inserted into the recesses 80 in the toothed ring 8. Cylindrical projections 71 are further formed on the coupling element 7 on the side facing the lever 3, which projections are arranged on a circular orbit and can be inserted into respective openings 30 on the lever 3. Depending on the angular position, the lever 3 can be connected with the coupling element 7 in a predetermined angular position.

The central rivet 4 holds the latching fitting together in the axial direction, with a rivet-like widened portion 43 supporting the lever 3 on the outside. A radially protruding flange 40 is formed on the opposite side, which flange supports the lever 2. The central rivet 4 comprises an enlarged section 41 which penetrates the opening 20, the opening 50 and the opening 62 of the latching disk 6. A tapering cylindrical section 42 of the central rivet 4 penetrates an opening 70 of the coupling element 7 and an opening 90 of a spring element 9 and the opening 31 of the lever 3.

FIG. 2 shows the latching fitting 1 in a top view. The levers 2 and 3 can be pivoted in a predetermined angular range in one direction relative to one another, whereas they are locked with respect to each other in the opposite direction of rotation. Upon reaching an end position, the toothed ring 8 will be lifted off and the lever 3 or 2 can be pivoted back until an initial position has been reached.

FIG. 3 shows the middle area of the latching fitting 1 in the assembled position. The individual components are mounted to be rotatable about the central rivet 4, with the spring 9 being arranged as a leaf spring and resting on an annular middle section 91 on the lever 3. In an outer region the limbs 92 of the leaf spring rest on the toothed ring 8 and press the same against the tooth system 5. The drawing further shows that the pins 52 penetrate the lever 2 and the tooth system 5, and that they are rotatable with the enlarged section 53 in the oblong holes 61 in the region of the latching disk 6.

FIG. 4 shows the latching disk 6 in detail, which comprises two arc-shaped oblong holes 61 and four V-shaped projections 60.

As is shown in FIG. 5, the latching disk 6 can produce a lifting off of the toothed ring 8 from the tooth system 5 with the projections 60 when an inwardly facing projection 81 of the toothed ring is moved via a guide bevel on the projection 60. This will occur when the enlarged section 53 of the bolt 52 reaches the end of the oblong hole 62 and the latching disk 6 is thereby rotated together with the pin 52.

FIG. 6 shows the position when the toothed ring 8 is in engagement with the tooth system 5 and is kept in engagement by the spring element 9. The projections 60 are distributed over the circumference and are arranged in respective recesses between two projections 81 on the inside of the toothed ring 8. Four projections 60 are arranged in a distributed manner over the circumference.

As is shown in FIG. 7, each of the projections 60 comprises two guide bevels 63 and 64 which lift off or subsequently lower the cuboid projection 81 on the toothed ring 8 during a rotational movement relative to one another.

This lifting and subsequent lowering in the axial direction can be influenced by the angular sizes of the V-shaped guide bevels 63, 64. The larger the angle of the V-shaped guide bevels 63, 64, the longer the inclined planes and the longer the delay in the lowering (threading) of the toothed ring 8. This relatively delayed lowering of the toothed ring 8 leads to the advantage that loud impact noises are consequently dampened.

FIGS. 8 and 9 show the tooth system 5 and the toothed ring 8 in a side view. The tooth system comprises teeth with a tooth flank 82 which is arranged as a guide bevel, so that the toothed ring 8 is freely rotatable on the tooth system 5 in one direction, with the toothed ring 8 being lifted off by the guide bevel and being then pressed by the force of the spring 9 into the next tooth space. The second tooth flank 83 is arranged in an inclined manner in one direction parallel to the rotational axis through the central rivet 4, preferably at an angle of between 2° and 5°, so that the teeth of the tooth system 5 and the toothed ring 8 will claw into one another under high torque.

FIGS. 10A and 10B show a modified embodiment of a lever 2′, which can be used in a latching fitting one according to FIG. 1. The lever 2′ comprises an extension arm 20′ and a disk-like receiver 21′, in which a middle opening 22′ is recessed in form of a hexagon. A hexagonal projection 24′ of a shell 23′ is inserted into the recess 22′, in which the tooth system 5 will be mounted subsequently. As a result of the two-part configuration of the lever 2′ it is possible to adjust the direction of the extension arm 20′ relative to the shell 23′. Moreover, the length of the extension arm 20′ and the geometry can be varied, which is advantageous for special applications. Instead of the illustrated hexagonal projections 24′; 24″ and receivers 21′, 21″, it is also possible to provide other connections, preferably interlocking connections, in order to transmit the torque forces.

FIGS. 11A and 11B show a modified embodiment of a lever 2″ in which a hexagonal projection 24″ is arranged on a shell 23″, as is shown in the preceding embodiment. The tooth system 5 can be mounted on the shell 23″ again. An axial extension with a receiver 21″ for coupling with the projection 24″ is provided instead of an extension arm 20″. A bar 20″ is connected to the receiver 21″, which bar is provided at the end side with a coupling element 26″. The shape of the lever 2, 2′, 2″ can be freely varied over a wide margin. It is therefore possible for example to arrange a bar 20″ in extension as a connecting element in such a way that it transmits forces between a first and second latching fitting for synchronized movement of the first and second latching fitting.

It is further possible to use only one latching fitting for latching in order to transmit a desired synchronized movement with such a connecting element to a simple joint or a joint that is not provided with latching.

1. A latching fitting (1), especially for adjusting furniture parts, comprising a first lever (2, 2′, 2″) and a second lever (3) which is mounted on said first lever (2, 2′, 2″) in a rotatable manner, with a tooth system (5) which is arranged in the form of a ring around a rotational axis being arranged on the first lever (2, 2′, 2″), which tooth system engages with a toothed ring (8), with the tooth system (5) and the toothed ring (8) being locked with respect to one another in a first direction of rotation and being rotatable relative to one another about a predetermined angular range in a second direction of rotation, characterized in that the toothed ring (8) is arranged in the manner of a ring and is displaceable via a switching element parallel the rotational axis relative to a coupling element (7) arranged in the toothed ring (8).

2. A latching fitting according to claim 1, characterized in that the coupling element (7) comprises a profiling (72) on the outer circumference which is in engagement in an interlocking fashion with a profiling (80) on the toothed ring (8), and at least one driver (71) is arranged on the side facing the second lever (3), said driver being coupled with the second lever (3).

3. A latching fitting according to claim 2, characterized in that several projections (71) are provided on the coupling element (7) in the axial direction, said projections being inserted into receivers (30) on the second lever (3).

4. A latching fitting according to claim 1, characterized in that the coupling element (7) can be fixed on the second lever (3) in different angular positions.

5. A latching fitting according to claim 1, characterized in that the tooth system (5) on the first lever (2, 2′, 2″) is arranged as a separate component which can be fixed on the first lever (2, 2′, 2″) in different angular positions.

6. A latching fitting according to claim 1, characterized in that a latching disk (6) is provided as a switching element, on which at least one guide bevel (63, 64) is arranged for displacing the toothed ring (8) in the axial direction.

7. A latching fitting according to claim 6, characterized in that the latching disk (6) comprises at least three, preferably four, guide bevels (63, 64) which are distributed over the circumference.

8. A latching fitting according to claim 1, characterized in that the toothed ring (8) comprises at least one projection (81) on its inner face edge, which projection can be moved along a guide bevel (63, 64) of the latching disk (6).

9. A latching fitting according to claim 6, characterized in that the latching disk (6) is arranged between the coupling element (7) and the disk-like tooth system (5).

10. A latching fitting according to claim 1, characterized in that the toothed ring (8) is pretensioned relative to the tooth system (5) via a leaf spring arranged between the second lever (3) and the toothed ring (8).

11. A latching fitting according to claim 1, characterized in that the toothing (5) is fixed via at least one pin (52) on the first lever (2), and the pin (52) penetrates an oblong hole (61) of a latching disk (6).

12. A latching fitting according to claim 1, characterized in that the teeth of the tooth system (5) and the toothed ring (8) have an undercut which is arranged at an incline relative to the rotational axis.
